(19) United States
(12) Patent Application Publication
(10) Pub. No.: US 2016/0378510 A1
(43) Pub. Date: Dec. 29, 2016

(54) Configuration Method, Data Exchange Method and Server System

(71) Applicants: Beijing Lenovo Software Ltd., Beijing (CN); Lenovo (Beijing) Co., Ltd., Beijing (CN)

(72) Inventors: Junxian Ye, Beijing (CN); Shidian Cheng, Beijing (CN); Shouyi Qiu, Beijing (CN)

(73) Assignees: Beijing Lenovo Software Ltd., Beijing (CN); Lenovo (Beijing) Co., Ltd., Beijing (CN)

(21) Appl. No.: 14/978,626

(22) Filed: Dec. 22, 2015

(30) Foreign Application Priority Data
Jun. 29, 2015 (CN) 201510370099.9

(51) Int. Cl. G06F 9/44; G06F 3/06

(52) U.S. Cl. CPC G06F 9/4416; G06F 3/0689; G06F 3/0619; G06F 3/0665

(57) ABSTRACT

A configuration method, a data exchange method, and a server system are described. The configuration method includes virtualizing at least one first storage apparatus into a number of M booting virtual storage space, and virtualizing at least one second storage apparatus into a number of M data virtual storage space, wherein M is an integer larger than or equal to 2; creating the i-th first corresponding relationship between the i-th server of the number of M servers and the i-th booting virtual storage space of the number of M booting virtual storage space with i from 1 to M in order; creating the i-th second corresponding relationship between the i-th server and the i-th data virtual storage space of the number of M data virtual storage space, with i from 1 to M in order.

This application claims priority to Chinese Patent Application No. 201510370099.9 filed Jun. 29, 2015, the entire contents of which are incorporated herein by reference.

The present disclosure relates to the electrical technical field, and particularly to a configuration method, a data exchange method and a server system.

### BACKGROUND

With the development of the technology and science, a server is widely applied. In the application of the server, one server uses a set of RAID (Redundant Arrays of Independent Disks) 1 hard disk group to establish a robust server operation environment. However, in the application of a material center, since there is a large amount of servers, the establishment of a set of RAID 1 hard disk group by each server separately is costly. Therefore, in the application of the material center, it begins to use a structural design in which an iSCSI (Internet Small Computer System Interface) is to be a material center infrastructure, and the total cost is reduced by using the RAID 1 hard disk group in common.

The iSCSI infrastructure in the prior art mainly uses a frequency bandwidth of 10 Gb Ethernet, and the startup requirements for only 20 servers can be satisfied. If the number of servers supported is to be increased, generally, a costly high-speed storage network solution managed centralizedly, that is, an SAN network storage, is used.

The inventors of the present disclosure found the following technical solutions in the prior art when implementing the technical solution of the embodiment of the present disclosure.

Only 20 servers can be supported in the iSCSI structure due to its network frequency bandwidth in the iSCSI structure in the prior art. Then, when there is a large amount of servers, the iSCSI structure cannot satisfy the data storage and exchange requirements for all servers. Therefore, there is a technical problem of a limited number of servers supported in the iSCSI structure in the prior art.

### SUMMARY

A configuration method, a data exchange method and a server system are provided in embodiments of the present disclosure, for solving the technical problem of a limited number of servers supported in the iSCSI structure in the prior art, and realizing a technical effect of providing a high frequency bandwidth connection structure and increasing the amount of servers supported.

In an aspect of the present disclosure, a configuration method applied to a server system is provided, comprising: virtualizing at least one first storage apparatus into a number of M booting virtual storage space, and virtualizing at least one second storage apparatus into a number of M data virtual storage space, the at least one first storage apparatus and the at least one second storage apparatus being connected to at least one switch, the at least one switch being connected to a number of M servers, and each server of the at least one switch being connected to a management apparatus in the server system, wherein M is an integer larger than or equal to 2; creating the i-th first corresponding relationship between the i-th server of the number of M servers and the i-th booting virtual storage space of the number of M booting virtual storage space, with i from 1 to M in order, and obtaining a number of M first corresponding relationships when i is M; creating the i-th second corresponding relationship between the i-th server and the i-th data virtual storage space of the number of M data virtual storage space, with i from 1 to M in order, and obtaining a number of M second corresponding relationships when i is M.

Optionally, the method further comprises: virtualizing at least one network card connected to one or more switch(es) of the at least one switch into a number of M virtual network cards; creating the i-th third corresponding relationship between the i-th server and the i-th virtual network card in the number of M virtual network cards, with i from 1 to M in order, and obtaining a number of M third corresponding relationships when i is M.

Optionally, each switch of the at least one switch is a PCIE switch, and each network card of the at least one network card is a HBA network card.

Optionally, after creating the i-th first corresponding relationship, the i-th server is allowed to obtain the i-th server boot data of the i-th server from the i-th booting virtual storage space only; after creating the i-th second corresponding relationship, the i-th server is allowed to write data required to be written into the i-th data virtual storage space only, the i-th server is allowed to read data from each data virtual storage space of the number of M data virtual storage space; after creating the i-th third corresponding relationship, the i-th server is allowed to exchange data through the i-th virtual network card and a cloud side device only.

In another aspect of the present disclosure, a data exchange method applied to a server system is provided, comprising: obtaining a data operation instruction for the i-th server of a number of M servers in the server system, at least one first storage apparatus and at least one second storage apparatus in the server system being connected to at least one switch, the at least one switch being connected to the number of M servers and each switch in the at least one switch being connected to a management apparatus in the server system; determining the i-th virtual data apparatus corresponding to the i-th server, based on a number of M corresponding relationships between the number of M servers and a number of M virtual data apparatuses for data read/write or exchange; performing the data operation instruction so that the i-th server performs corresponding data operation on the i-th virtual data apparatus.

Optionally, the step of obtaining the data operation instruction for the i-th server of a number of M servers in the server system comprises: obtaining a system booting data reading instruction for reading the i-th system booting data of the i-th server from the i-th server of the number of M servers in the server system; or obtaining a data writing instruction for saving first data from the i-th server of the number of M servers in the server system; or obtaining a data exchange instruction for exchanging data with a cloud side device from the i-th server of the number of M servers in the server system.

Optionally, when the data operation instruction is the system booting data reading instruction, the step of determining the i-th virtual data apparatus corresponding to the i-th server, based on the number of M corresponding relationships between the number of M servers and the number of M virtual data apparatuses for data read/write or exchange comprises: determining the i-th booting virtual storage space corresponding to the i-th server from a number of M booting virtual storage space obtained by virtualizing the at least one first storage apparatus, based on a number of M first corresponding relationships, wherein the number of M first corresponding relationships are corresponding relationships between the number of M servers and the number of M booting virtual storage space; and the step of performing the data operation instruction so that the i-th server performs corresponding data operation on the i-th virtual data apparatus comprises: performing the system booting data reading instruction, so that the i-th server reads the i-th server booting data from the i-th booting virtual storage space.

Optionally, when the data operation instruction is the data writing instruction, the step of determining the i-th virtual data apparatus corresponding to the i-th server, based on the number of M corresponding relationships between the number of M servers and the number of M virtual data apparatuses for data read/write or exchange comprises: determining the i-th data virtual storage space corresponding to the i-th server from a number of M data virtual storage space obtained by virtualizing the at least one second storage apparatus, based on a number of M second corresponding relationships, wherein the number of M second corresponding relationships are corresponding relationships between the number of M servers and the number of M data virtual storage space; and the step of performing the data operation instruction so that the i-th server performs corresponding data operation on the i-th virtual data apparatus comprises: performing the data writing instruction so that the i-th server writes the first data into the i-th data virtual storage space.

Optionally, when the data operation instruction is the data exchange instruction, the step of determining the i-th virtual data apparatus corresponding to the i-th server, based on the number of M corresponding relationships between the number of M servers and the number of M virtual data apparatuses for data read/write or exchange comprises: determining the i-th virtual network card corresponding to the i-th server from a number of M virtual network cards obtained by virtualizing at least one network card connected to one or more switch(es) of the at least one switch, based on a number of M third corresponding relationships, wherein the number of M third corresponding relationships are corresponding relationships between the number of M servers and the number of M virtual network cards; and the step of performing the data operation instruction so that the i-th server performs corresponding data operation on the i-th virtual data apparatus comprises: performing the data exchange instruction, so that the i-th server exchanges data with the cloud side device through the i-th virtual network card.

In a further aspect of the present disclosure, a server system is provided, comprising: at least one first storage apparatus corresponding to a number of M booting virtual storage space; at least one second storage apparatus corresponding to a number of M data virtual storage space; at least one switch connected to the at least one first storage apparatus and the at least one second storage apparatus; a number of M servers connected to the at least one switch; a management apparatus connected to the number of M servers; wherein, through the management apparatus, the i-th first corresponding relationship is created between the i-th server of the number of M servers and the i-th booting virtual storage space of the number of M booting virtual storage space, so that a total number of M first corresponding relationships are created; and the i-th second corresponding relationship is created between the i-th server and the i-th data virtual storage space of the number of M data virtual storage space, so that a total number of M second corresponding relationships are created.

Optionally, the server system further comprises at least one network card connected to one or more switch(es) of the at least one switch, the at least one switch being virtualized into a number of M virtual network cards; wherein the i-th third corresponding relationship is created between the i-th server of the number of M servers and the i-th virtual network card of the number of M virtual network cards, wherein i is anyone integer between 1 and M.

Optionally, wherein each switch of the at least one switch is a PCIE switch, and each network card of the at least one network card is a HBA network card.

Optionally, the i-th server is allowed to obtain the i-th server boot data of the i-th server from the i-th booting virtual storage space only; the i-th server is allowed to write data required to be written into the i-th data virtual storage space only, the i-th server is allowed to read data from each data virtual storage space of the number of M data virtual storage space; the i-th server is allowed to exchange data through the i-th virtual network card and a cloud side device.

With one or more technical solutions of the embodiments of the present disclosure as described above, at least one or more technical effects may be achieved.

Firstly, in the technical solution of the present disclosure, at least one first storage apparatus is virtualized into a number of M booting virtual storage space, the at least one first storage apparatus being connected to at least one switch, the at least one switch being connected to a number of M servers, and each server of the at least one switch being connected to a management apparatus in the server system. The i-th first corresponding relationship between the i-th server of the number of M servers and the i-th booting virtual storage space of the number of M booting virtual storage space is created, with i from 1 to M in order. In this way, at least one switch shares the first storage apparatus in a way of virtualizing hardware, increasing the frequency bandwidth for the sharing storage. Then, the first storage apparatus is virtualized into multiple virtual storage space the number of which is the same as that of the servers, thereby, each server has a corresponding storage space for startup booting information to support the startup requirement for the servers. Therefore, the technical problem of the limited number of servers supported in the iSCSI structure in the prior art is effectively solved and the technical effect of increasing the number of servers that can be supported by the server system is achieved.

Secondly, in the technical solution of the present disclosure, at least one second storage apparatus is virtualized into a number of M data virtual storage space, the at least one second storage apparatus being connected to at least one switch, the at least one switch being connected to a number of M servers, and each server of the at least one switch being connected to a management apparatus in the server system. The i-th second corresponding relationship between the i-th server and the i-th data virtual storage space of the number of M data virtual storage space is created, with i from 1 to M in order. Then, each server can store data to be written into the second storage apparatus. Since each server can acquire corresponding information from the second storage apparatus, the technical effect of sharing material by sharing the storage hard disk is achieved.

Thirdly, in the technical solution of the present disclosure, at least one network card connected to one or more switch(es) of the at least one switch is virtualized into a number of M virtual network cards. The i-th third corresponding relationship between the i-th server and the i-th virtual network card in the number of M virtual network cards is created, with i from 1 to M in order. Then, at least one switch virtualizes the at least one network card into multiple virtual network cards the number of which is the same as that of the servers, by way of virtualization, so that each server may acquire network resource through the at least one network card, and the technical effect of sharing the network card is achieved.

Fourthly, in the technical solution of the present disclosure, each switch of the at least one switch is a PCIE switch. Then, the user may plan the frequency bandwidth flexibly according to practical need using the couplable-ness of the PCIe bus in the PCIE switch. Since the main types of the normal PCIe buses are PCIe×4, PCIe×8 and PCIe×16, the server system in the embodiments of the present disclosure achieves the technical effect of being capable of providing the frequency bandwidth of 32˜128 GT/s.

Fifthly, in the technical solution of the present disclosure, each switch of the at least one switch is a PCIE switch. Then, the shared network card in the server system may reduce one level of Ethernet switch in the network infrastructure of the material center. Therefore, the technical effect of reducing the cost for a material transfer device in the server system is achieved.

### BRIEF DESCRIPTION OF THE DRAWINGS

In order to describe the technical solution of the embodiments of the present disclosure or the prior art, the accompany drawings required to be used in the description of the embodiments will be described briefly. Apparently, the accompany drawings in the following description are only some embodiments of the present disclosure.

FIG. 1 is a flowchart of a configuration method provided in a first embodiment of the present disclosure;

FIG. 2 is a schematic diagram of a number of M first corresponding relationships between a number of M servers and a number of M booting virtual storage space in the first embodiment of the present disclosure;

FIG. 3 is a schematic diagram of a number of M second corresponding relationships between a number of M servers and a number of M data virtual storage space in the first embodiment of the present disclosure;

FIG. 4 is a schematic diagram of a number of M third corresponding relationships between a number of M servers and a number of M virtual network paths in the first embodiment of the present disclosure;

FIG. 5 is a flowchart of a data exchange method provided in a second embodiment of the present disclosure;

FIG. 6 is a flowchart of a first implementation of steps S202 and S203 in the second embodiment of the present disclosure;

FIG. 7 is a flowchart of a second implementation of steps S202 and S203 in the second embodiment of the present disclosure;

FIG. 8 is a flowchart of a second implementation of steps S202 and S203 in the third embodiment of the present disclosure; and

FIG. 9 is a block diagram showing a structure of a server system provided in a third embodiment of the present disclosure.

### DETAILED DESCRIPTION

A configuration method, a data exchange method and a server system are provided in embodiments of the present disclosure, for solving the technical problem of a limited number of servers supported in the iSCSI structure in the prior art, and realizing a technical effect of providing a high frequency bandwidth connection structure and increasing the amount of servers supported.

In order to solve the above technical problem, the general idea of the technical solutions in embodiments of the present disclosure is as follows.

A configuration method is applied to a server system, comprising: virtualizing at least one first storage apparatus into a number of M booting virtual storage space, and virtualizing at least one second storage apparatus into a number of M data virtual storage space, the at least one first storage apparatus and the at least one second storage apparatus being connected to at least one switch, the at least one switch being connected to a number of M servers, and each server of the at least one switch being connected to a management apparatus in the server system, wherein M is an integer larger than or equal to 2; creating the i-th first corresponding relationship between the i-th server of the number of M servers and the i-th booting virtual storage space of the number of M booting virtual storage space with i from 1 to M in order, and obtaining a number of M first corresponding relationships when i is M; creating the i-th second corresponding relationship between the i-th server and the i-th data virtual storage space of the number of M data virtual storage space, with i from 1 to M in order, and obtaining a number of M second corresponding relationships when i is M.

In the technical solution described above, at least one first storage apparatus is virtualized into a number of M booting virtual storage space, the at least one first storage apparatus being connected to at least one switch, the at least one switch being connected to a number of M servers, and each server of the at least one switch being connected to a management apparatus in the server system. The i-th first corresponding relationship between the i-th server of the number of M servers and the i-th booting virtual storage space of the number of M booting virtual storage space is created, with i from 1 to M in order. In this way, at least one switch shares the first storage apparatus in a way of virtualizing hardware, increasing the frequency bandwidth for the sharing storage. Then, the first storage apparatus is virtualized into multiple virtual storage space the number of which is the same as that of the servers, thereby, each server has a corresponding storage space for startup booting information to support the startup requirement for the servers. Therefore, the technical problem of the limited number of servers supported in the iSCSI structure in the prior art is effectively solved and the technical effect of increasing the number of servers that can be supported by the server system is achieved.

In order to make the object, the technical solution and the technical effect of the embodiments of the present disclosure more clear, the technical solution of the present disclosure will be described clearly and thoroughly with reference to the accompany drawings hereinafter. Apparently, the described embodiments are only a part of, but not all, embodiments of the present disclosure. All the other embodiments derived by those skilled in the art based on the embodiments described in the present application without inventive labor shall fall within the protection scope of the technical solution of the present disclosure.

### First Embodiment

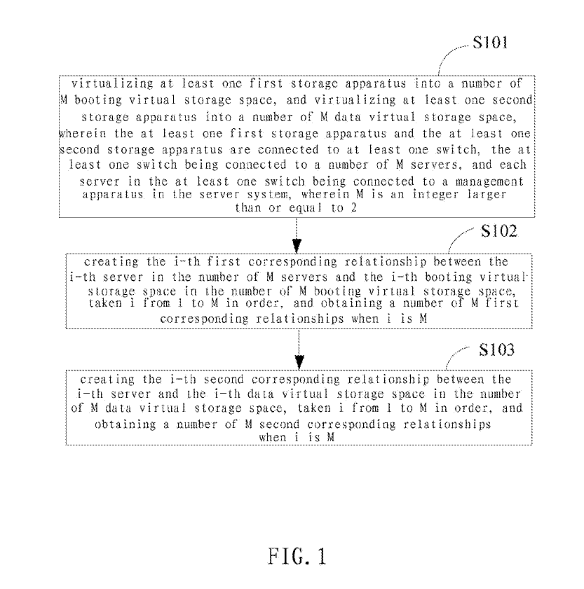

Referring to FIG. 1, a configuration method is provided in a first embodiment of the present disclosure, which is applied to a server system. The method comprises the following steps.

In a step S101, at least one first storage apparatus is virtualized into a number of M booting virtual storage space, and at least one second storage apparatus is virtualized into a number of M data virtual storage space, the at least one first storage apparatus and the at least one second storage apparatus being connected to at least one switch, the at least one switch being connected to a number of M servers, and each server of the at least one switch being connected to a management apparatus in the server system, wherein M is an integer larger than or equal to 2.

In a step S102, the i-th first corresponding relationship between the i-th server of the number of M servers and the i-th booting virtual storage space of the number of M booting virtual storage space is created, with i from 1 to M in order, and a number of M first corresponding relationships are obtained when i is M.

In a step S103, the i-th second corresponding relationship between the i-th server and the i-th data virtual storage space of the number of M data virtual storage space is created, with i from 1 to M in order, and a number of M second corresponding relationships are obtained when i is M.

In a detailed implementation, the method in the embodiment of the present disclosure will be described in detail with the server system being a server system of a material center as an example.

The first storage apparatus may be a RAID 1 memory card, the second storage apparatus may be a RAID 0 memory card. Meanwhile, each RAID 1 or RAID 0 memory card is connected to the switch through a RAID controller. Particularly, one RAID controller may be connected to one RAID 1 and one RAID 0 at the same. Alternatively, two RAID controllers are connected to one RAID 1 and one RAID 0. In a particular implementation, it may be set according to the type of the RAID controller and the type of the RAID card, and will not be limited in the present disclosure.

Then, the RAID controller is connected to at least one switch. Each switch of the at least one switch is a PCIE switch. The number of the switches may be decided according to the number of servers required to be supported and the bus type of the PCIe in the PCIE switch. In the embodiment of the present disclosure, a detail description will be made taking the frequency bandwidth connection scheme supporting 64 server nodes and PCIe×8 as an example. Using 8 PCIE switches and arranging them into an upper layer and a lower layer, there are 2 PCIE switches in the first layer and 6 PCIE switches in the second layer. The PCIE switch in the first layer is connected to the PCIE switch in the second layer and the RAID controller, the front end of the PCIE switch in the second layer is connected to the PCIE switch in the first layer, and the back end of the PCIE switch is connected to the server. Meanwhile, the eight PCIE switches are all connected to the management CPU.

In the configuration method according to the embodiment of the present disclosure, when it is to be configured, first, the step S101 is performed. That is, at least one first storage apparatus is virtualized into a number of M booting virtual storage space, and at least one second storage apparatus is virtualized into a number of M data virtual storage space, the at least one first storage apparatus and the at least one second storage apparatus being connected to at least one switch, the at least one switch being connected to a number of M servers, and each server of the at least one switch being connected to a management apparatus in the server system, wherein M is an integer larger than or equal to 2.

In the detailed implementation, still taking the above as an example, the management CPU virtualizes the at least one RAID 0 memory card and the at least one RAID 1 memory card into multiple storage space respectively through the RAID controller connected to the PCIE switch in the first layer. Since there are 64 server nodes, the at least one RAID 1 memory card is virtualized into 64 booting virtual storage space for storing the startup booting data of 64 servers. The at least one RAID 0 memory card is virtualized into 64 data virtual storage space for storing non-booting data of the 64 servers, wherein the number of RAID 0 and RAID 1 memory cards may be selected according to the practical requirement.

After performing the step S101, the method in the embodiment of the present disclosure performs the step S102. That is, the i-th first corresponding relationship between the i-th server of the number of M servers and the i-th booting virtual storage space of the number of M booting virtual storage space is created, with i from 1 to M in order, and a number of M first corresponding relationships are obtained when i is M.

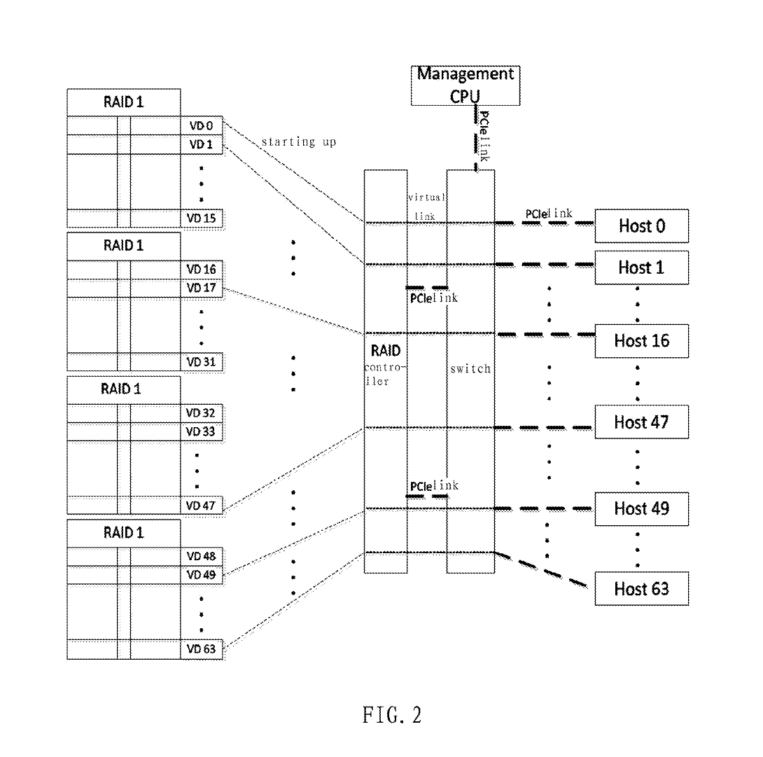

In the detailed implementation, still taking the above as an example, when the management CPU virtualizes the at least one RAID 1 memory card into 64 booting virtual storage space and virtualizes the at least one RAID 0 memory card into 64 data virtual storage space, the management CPU performs allocation for each booting virtual storage space. For example, it allocates the first booting virtual storage space (VD 0) of the 64 booting virtual storage space to Host 0, allocates VD 1 to Host 1, or the like, sets the booting virtual storage space corresponding to each server, and obtains a corresponding relationship between the 64 servers and the booting virtual storage space in the RAID 1 memory card, as shown in FIG. 2.

After performing the step S102, the method in the embodiment of the present disclosure performs the step S103. That is, the i-th second corresponding relationship between the i-th server and the i-th data virtual storage space of the number of M data virtual storage space is created, with i from 1 to M in order, and a number of M second corresponding relationships are obtained when i is M.

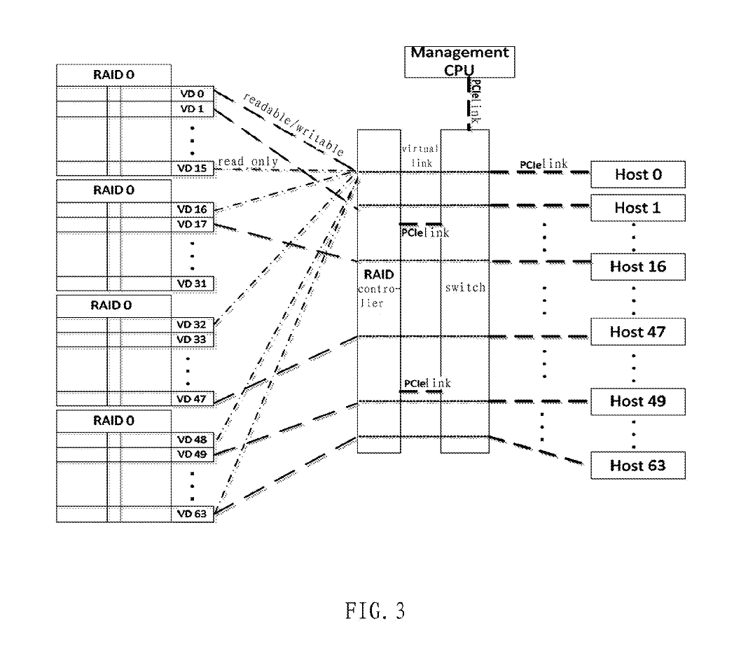

In the detailed implementation, still taking the above as an example, when the management CPU virtualizes the at least one RAID 1 memory card into 64 booting virtual storage space and virtualizes the at least one RAID 0 memory card into 64 data virtual storage space, the management CPU performs allocation for each data virtual storage space. For example, it allocates the first data virtual storage space (VD 0) of the 64 data virtual storage space to Host 0, allocates VD 1 to Host 1, or the like, sets the data virtual storage space corresponding to each server, and obtains the corresponding relationship between the 64 servers and the data virtual storage space in the RAID 0 memory card. At this time, each server will store the data required to be stored into the corresponding data virtual storage space. Meanwhile, a right for each server to each data virtual storage space may be set as well. For example, the right for Host 0 to VD 1˜VD63 is read only. In this way, Host 0 can only read data from VD1˜VD63, but cannot edit data, as shown in FIG. 3.

In the embodiment of the present disclosure, the method further comprises: virtualizing at least one network card connected to one or more switch(es) of the at least one switch into a number of M virtual network cards; creating the i-th third corresponding relationship between the i-th server and the i-th virtual network card in the number of M virtual network cards, with i from 1 to M in order, and obtaining a number of M third corresponding relationships when i is M.

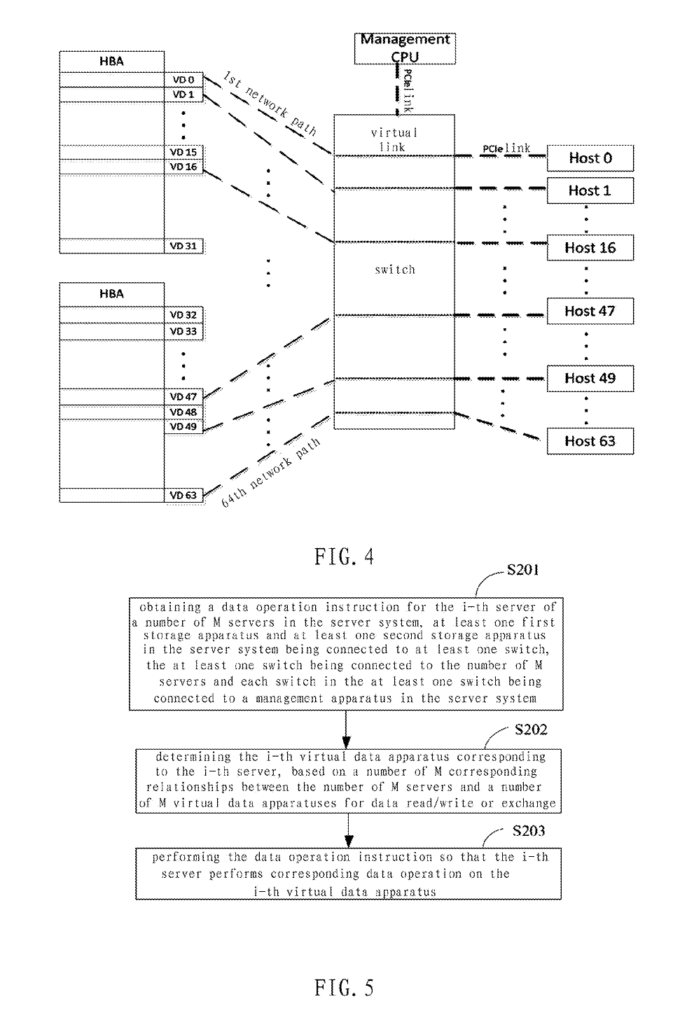

In a detailed implementation, each network card of the at least one network card is a HBA network card. Taking the above as an example, in the frequency bandwidth connection scheme of PCIe×8 with 64 server nodes supported, 2 HBA network cards are adopted. Each HBA network card is connected to any one PCIE switch of the PCIE switches in the first layer respectively. The management CPU virtualizes the HBA network card into 64 network paths through the PCIE switch connected to each HBA network card. Each HBA network card is virtualized into 32 network paths, and each network paths is allocated to 64 server nodes. For example, the first network path in the first HBA network card is allocated to Host 0, the first network paths in the second HBA network card is allocated to Host 32, or the lie, thereby, the corresponding relationships between the 64 servers and the network paths in the HBA network card are obtained, as shown in FIG. 4.

In the embodiment of the present disclosure, after creating the i-th first corresponding relationship, the i-th server is allowed to obtain the i-th server boot data of the i-th server from the i-th booting virtual storage space only.

After creating the i-th second corresponding relationship, the i-th server is allowed to write data required to be written into the i-th data virtual storage space only, the i-th server is allowed to read data from each data virtual storage space of the number of M data virtual storage space.

After creating the i-th third corresponding relationship, the i-th server is allowed to exchange data through the i-th virtual network card and a cloud side device.

In the detailed implementation, still taking the above as an example, after determining that the Host 0 corresponds to the first booting virtual storage space in the RAID 0 memory card, the first data virtual storage space in the RAID 0 memory card and the first network path in the first HBA network card, when the Host 0 is started up, it will read the startup data from the first booting virtual storage space in the RAID 1 memory card to satisfy the startup requirement. When the Host 0 needs to store data, it will store data into the first data virtual storage space in the RAID0 memory card automatically. Meanwhile, Host 0 can read data from all virtual storage space in the RAID 0 memory card. For example, Host 0 may read data from VD 14, VD 17 of RAID 0. When Host 0 needs to exchange data with the cloud side, Host 0 will exchange data through the first network path in the first HBA network card automatically.

### Second Embodiment

Based on the same inventive concept as the first embodiment of the present disclosure, a data exchange method is provided in the second embodiment of the present disclosure, as shown in FIG. 5. The method is applied to a server system, and comprises the following steps.

At a step S201, a data operation instruction for the i-th server of a number of M servers in the server system is obtained, at least one first storage apparatus and at least one second storage apparatus in the server system being connected to at least one switch, the at least one switch being connected to the number of M servers and each switch in the at least one switch being connected to a management apparatus in the server system.

At a step S202, the i-th virtual data apparatus corresponding to the i-th server is determined based on a number of M corresponding relationships between the number of M servers and a number of M virtual data apparatuses for data read/write or exchange.

At a step S203, the data operation instruction is performed so that the i-th server performs corresponding data operation on the i-th virtual data apparatus.

In a detailed implementation, the method in the embodiment of the present disclosure will be described in detail with the server system being a server system of a material center as an example. The first storage apparatus of the server system of the material center may be a RAID 1 memory card, the second storage apparatus may be a RAID 0 memory card. Meanwhile, each RAID 1 or RAID 0 memory card is connected to the switch through a RAID controller. Particularly, one RAID controller may be connected to one RAID 1 and one RAID 0 at the same. Alternatively, two RAID controllers are connected to one RAID 1 and one RAID 0. In a particular implementation, it may be set according to the type of the RAID controller and the type of the RAID card, and will not be limited in the present disclosure. Meanwhile, the RAID controller is connected to at least one switch. Each switch of the at least one switch is a PCIE switch. The number of switches may be decided according to the number of servers required to be supported and the bus type of the PCIe in the PCIE switch. In the embodiment of the present disclosure, a detail description will be made taking the frequency bandwidth connection scheme supporting 64 server nodes and PCIe×8 as an example. Using 8 PCIE switches and arranging them into an upper layer and a lower layer, there are 2 PCIE switches in the first layer and 6 PCIE switches in the second layer. The PCIE switch in the first layer is connected to the RAID controller and the PCIE switch in the second layer, the front end of the PCIE switch in the second layer is connected to the PCIE switch in the first layer, and the back end of the PCIE switch is connected to the server. Meanwhile, the eight PCIE switches are all connected to the management CPU.

In the configuration method according to the embodiment of the present disclosure, when it is to be configured, first, the step S201 is performed. That is, a data operation instruction for the i-th server of a number of M servers in the server system is obtained, at least one first storage apparatus and at least one second storage apparatus in the server system being connected to at least one switch, the at least one switch being connected to the number of M servers and each switch in the at least one switch being connected to a management apparatus in the server system.

In the embodiment of the present disclosure, the detailed implementation of the step S201 is as follows: obtaining a system booting data reading instruction for reading the i-th system booting data of the i-th server from the i-th server of the number of M servers in the server system; or obtaining a data writing instruction for saving first data from the i-th server of the number of M servers in the server system; or obtaining a data exchange instruction for exchanging data with a cloud side device from the i-th server of the number of M servers in the server system.

In the detailed implementation, still taking the above as an example, when Host 0 of the 64 servers is to be started up, the server system will obtain the system booting data reading instruction issued by Host 0. When Host 0 needs to store data in the storage space, the server system will obtain the data writing instruction issued by Host 0. When Host 0 needs to acquire data from the network side, the server system will obtain the data exchange instruction issued by Host 0.

After performing the step S201, the method in the embodiment of the present disclosure will perform the step S202. That is, the i-th virtual data apparatus corresponding to the i-th server is determined based on a number of M corresponding relationships between the number of M servers and a number of M virtual data apparatuses for data read/write or exchange.

In the embodiment of the present disclosure, since the obtained server operation instructions are different, there are three detailed implementations.

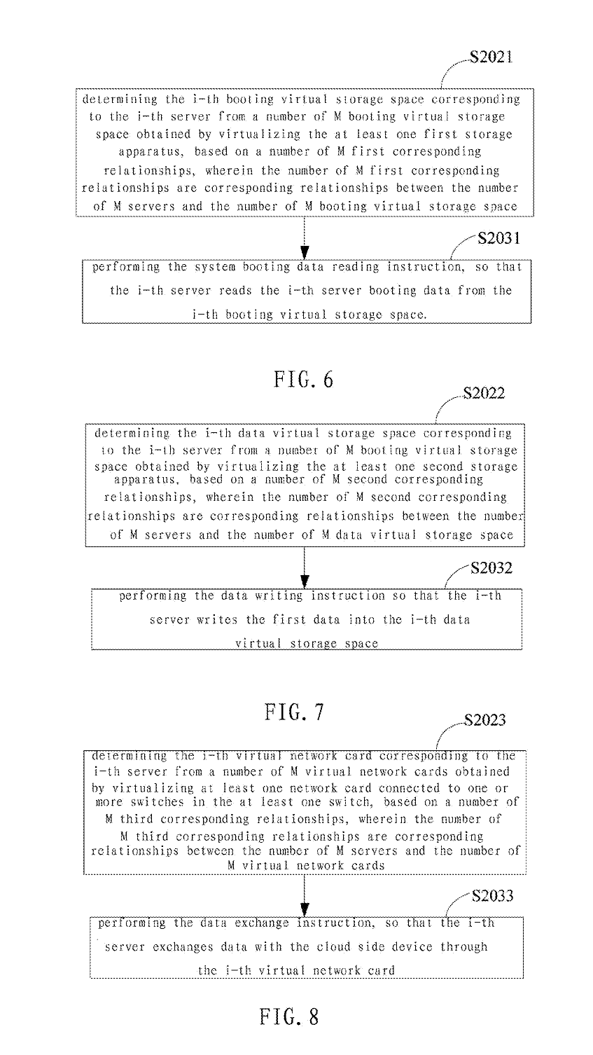

In a first way, referring to FIG. 6, when the data operation instruction is the system booting data reading instruction, the detailed implementation of the step S202 is as follows.

At a step S2021, the i-th booting virtual storage space corresponding to the i-th server is determined from a number of M booting virtual storage space obtained by virtualizing the at least one first storage apparatus, based on a number of M first corresponding relationships, wherein the number of M first corresponding relationships are corresponding relationships between the number of M servers and the number of M booting virtual storage space.

Accordingly, the detailed implementation of the step S203 is as follows.

At a step S2031, the system booting data reading instruction is performed, so that the i-th server reads the i-th server booting data from the i-th booting virtual storage space.

In the detailed implementation, still taking the above as an example, the management CPU virtualizes the at least one RAID 1 memory card into multiple storage space through the RAID controller connected to the PCIE switch in the first layer. Since there are 64 server nodes, the at least one RAID 1 memory card is virtualized into 64 booting virtual storage space for storing the startup booting data of 64 servers. Then, the management CPU performs allocation for each booting virtual storage space. For example, it allocates the first booting virtual storage space (VD 0) of the 64 booting virtual storage space to Host 0, allocates VD 1 to Host 1, or the like, sets the booting virtual storage space corresponding to each server, and obtains the corresponding relationship between the 64 servers and the booting virtual storage space in the RAID 1 memory card.

Taking an example in which Host 0 is started up, the server system obtains the system booting data reading instruction issued by Host 0, the server system determines the booting virtual storage space corresponding to Host 0 is VD 0 in RAID 1, based on the obtained corresponding relationship between the 64 servers and the booting virtual storage space in the RAID 0 memory card. Then, the booting virtual storage space is performed, the PCIE switch acquire the stored starting data from the storage space of VD0 in RAID 1, which is fed back to Host 0, so that Host 0 is started up.

In a second way, referring to FIG. 7, when the data operation instruction is the data writing instruction, the detailed implementation of the step of S202 is as follows.

In a step S2022, the i-th data virtual storage space corresponding to the i-th server is determined from a number of M data virtual storage space obtained by virtualizing the at least one second storage apparatus, based on a number of M second corresponding relationships, wherein the number of M second corresponding relationships are corresponding relationships between the number of M servers and the number of M data virtual storage space.

Accordingly, the detailed implementation of the step S203 is as follows.

At a step S2032, the data writing instruction is performed so that the i-th server writes the first data into the i-th data virtual storage space.

In the detailed implementation, still taking the above as an example, the management CPU virtualizes the at least one RAID 0 memory card into multiple storage space through the RAID controller connected to the PCIE switch in the first layer. Since there are 64 server nodes, the at least one RAID 0 memory card is virtualized into 64 data virtual storage space for storing data of 64 servers. Then, the management CPU performs allocation for each data virtual storage space. For example, it allocates the first data virtual storage space (VD 0) of the 64 data virtual storage space to Host 0, allocates VD 1 to Host 1, or the like, sets the data virtual storage space corresponding to each server, and obtains the corresponding relationship between the 64 servers and the data virtual storage space in the RAID 0 memory card.

Taking an example in which Host 0 is to write data, the server system obtains the data writing instruction issued by Host 0, the server system determines the data virtual storage space corresponding to Host 0 is VD 0 in RAID 0, based on the obtained corresponding relationship between the 64 servers and the data virtual storage space in the RAID 0 memory card. Then, the data writing instruction is performed, the PCIE switch writes the data required to be stored by Host 0 into the storage space of VD0 in RAID 0, so that the data writing operation of Host 0 is completed.

Similarly, when Host 0 needs to perform data reading operation, the server system may arrange the data virtual storage space corresponding to Host 0 as well, so that Host 0 can obtain the required data from the corresponding data virtual storage space. Of course, it is also possible for all servers in the server system to read any one virtual storage space in the data virtual storage space, so that the resource in the server system is shared.

In a third way, referring to FIG. 8, when the data operation instruction is the data exchange instruction, the detailed implementation of the step S202 is as follows.

In a step S2023, the i-th virtual network card corresponding to the i-th server is determined from a number of M virtual network cards obtained by virtualizing at least one network card connected to one or more switch(es) of the at least one switch, based on a number of M third corresponding relationships, wherein the number of M third corresponding relationships are corresponding relationships between the number of M servers and the number of M virtual network cards.

Accordingly, the detailed implementation of the step S203 is as follows.

At a step S2033, the data exchange instruction is performed, so that the i-th server exchanges data with the cloud side device through the i-th virtual network card.

In detailed implementation, the server system is also arranged with at least one network card. Taking the above as an example, in the frequency bandwidth connection scheme of PCIe×8 with 64 server nodes supported, 2 HBA network cards are adopted. Each HBA network card is connected to any one PCIE switch of the PCIE switches in the first layer respectively. The management CPU virtualizes the HBA network card into 64 network paths through the PCIE switch connected to each HBA network card. Each HBA network card is virtualized into 32 network paths, and each network path is allocated to 64 server nodes. For example, the first network path in the first HBA network card is allocated to Host 0, the first network card in the second HBA network card is allocated to Host 32, or the lie, thereby, the corresponding relationships between the 64 servers and the network paths in the HBA network card are obtained.

Taking an example in which Host 0 performs the data exchange operation, the server system obtains the data exchange instruction issued by Host 0. The server system determines the network path corresponding to Host 0 as the first network path in the first HBA network card, based on the obtained corresponding relationships between the 64 servers and the network paths in the HBA network card. Then, the data exchange instruction is performed, and the data at cloud side is accessed through the first HBA network card, and the acquired data is fed back to Host 0 via PCIE switch through the first network path in the first HBA network card, so that the data exchange operation of Host 0 is completed.

### Third Embodiment

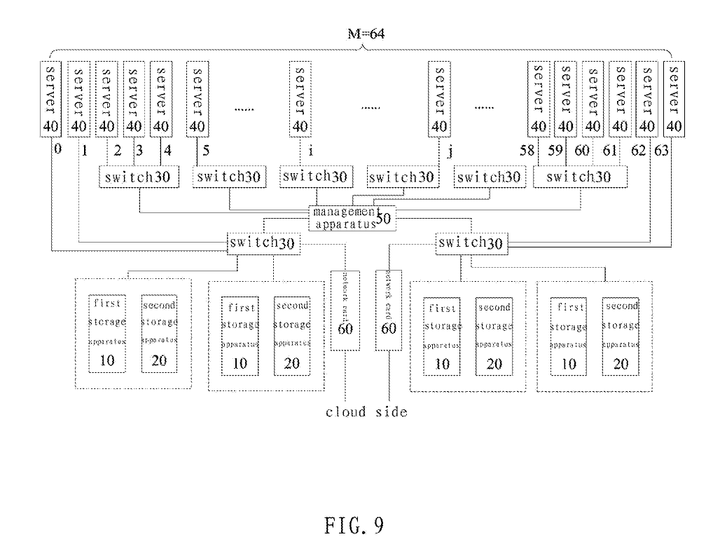

Referring to FIG. 9, based on the same inventive concept as the first embodiment of the present disclosure, a server system is provided in the third embodiment of the present disclosure, comprising: at least one first storage apparatus 10 corresponding to a number of M booting virtual storage space; at least one second storage apparatus 20 corresponding to a number of M data virtual storage space; at least one switch 30 connected to the at least one first storage apparatus 10 and the at least one second storage apparatus 20; a number of M servers 40 connected to the at least one switch 30; a management apparatus 50 connected to the number of M servers.

Wherein, the i-th first corresponding relationship is created between the i-th server of the number of M servers 40 and the i-th booting virtual storage space of the number of M booting virtual storage space through the management apparatus 50, so that a total number of M first corresponding relationships are created; and the i-th second corresponding relationship is created between the i-th server and the i-th data virtual storage space of the number of M data virtual storage space, so that a total number of M second corresponding relationships are created.

In the third embodiment of the present disclosure, the server system further comprises at least one network card 60 connected to one or more switch of the at least one switch 30, the at least one switch 60 being virtualized into a number of M virtual network cards.

Wherein the i-th third corresponding relationship is created between the i-th server of the number of M servers 40 and the i-th virtual network card of the number of M virtual network cards, wherein i is anyone integer between 1 and M.

In the third embodiment of the present disclosure, each switch of the at least one switch is a PCIE switch, and each network card of the at least one network card is a HBA network card.

In the third embodiment of the present disclosure, the i-th server is allowed to obtain the i-th server boot data of the i-th server from the i-th booting virtual storage space only; the i-th server is allowed to write data required to be written into the i-th data virtual storage space only, the i-th server is allowed to read data from each data virtual storage space of the number of M data virtual storage space; the i-th server is allowed to exchange data through the i-th virtual network card and a cloud side device.

In a detailed implementation, the first storage apparatus 10 may use an array of RAID 1 disk, the second storage apparatus 20 may use an array of RAID 0 magnetic disk, the switch 30 may be PLX9797. The server system also include at least one RAID controller connected to the PLX 9797, for virtualizing the at least one RAID 0 into a number of M booting virtual storage space and virtualizing the at least one RAID 1 into a number of M data virtual storage space.

With one or more technical solutions of the embodiments of the present disclosure as described above, at least one or more technical effects may be achieved.

Firstly, in the technical solution of the present disclosure, at least one first storage apparatus is virtualized into a number of M booting virtual storage space the at least one first storage apparatus being connected to at least one switch, the at least one switch being connected to a number of M servers, and each server of the at least one switch being connected to a management apparatus in the server system. The i-th first corresponding relationship between the i-th server of the number of M servers and the i-th booting virtual storage space of the number of M booting virtual storage space is created, with i from 1 to M in order. In this way, at least one switch shares the first storage apparatus in a way of virtualizing hardware, increasing the frequency bandwidth for the sharing storage. Then, the first storage apparatus is virtualized into multiple virtual storage space the number of which is the same as that of the servers, thereby, each server has a corresponding storage space for startup booting information to support the startup requirement for the servers. Therefore, the technical problem of the limited number of servers supported in the iSCSI structure in the prior art is effectively solved and the technical effect of increasing the number of servers that can be supported by the server system is achieved.

Secondly, in the technical solution of the present disclosure, at least one second storage apparatus is virtualized into a number of M data virtual storage space, the at least one second storage apparatus being connected to at least one switch, the at least one switch being connected to a number of M servers, and each server of the at least one switch being connected to a management apparatus in the server system; and the at least one second storage apparatus. The i-th second corresponding relationship between the i-th server and the i-th data virtual storage space of the number of M data virtual storage space is created, with i from 1 to M in order. Then, each server can store data to be written into the second storage apparatus. Since each server can acquire corresponding information from the second storage apparatus, the technical effect of sharing material by sharing the storage hard disk is achieved.

Thirdly, in the technical solution of the present disclosure, at least one network card connected to one or more switch(es) of the at least one switch is virtualized into a number of M virtual network cards. The i-th third corresponding relationship between the i-th server and the i-th virtual network card in the number of M virtual network cards is created, with i from 1 to M in order. Then, at least one switch virtualizes the at least one network card into multiple virtual network cards the number of which is the same as that of the servers, by way of virtualization, so that each server may acquire network resource through the at least one network card, and the technical effect of sharing the network card is achieved.

Fourthly, in the technical solution of the present disclosure, each switch of the at least one switch is a PCIE switch. Then, the user may plan the frequency bandwidth flexibly according to practical need using the couple of the PCIe bus in the PCIE switch. Since the main types of the normal PCIe buses are PCIe×4, PCIe×8 and PCIe×16, the server system in the embodiments of the present disclosure achieves the technical effect of being capable of providing the frequency bandwidth of 32˜128 GT/s.

Fifthly, in the technical solution of the present disclosure, each switch of the at least one switch is a PCIE switch. Then, the shared network card in the server system may reduce one level of Ethernet switch in the network infrastructure of the material center. Therefore, the technical effect of reducing the cost for a material transfer device in the server system is achieved.

Those skilled in the art shall understand that the embodiments of the present disclosure may be realized as methods, systems or computer program products. Therefore, the present disclosure may be realized in a way of entire hardware embodiment, entire software embodiment, or an embodiment with hardware and software in combination. In addition, the present disclosure may be realized in a way of a computer program product executed on one or more computer useable storage medium, which includes, but not limited to, a magnetic memory, a CD-ROM, an optical memory or the like, embodied with computer usable program code.

The present disclosure is described with reference to the flowchart and/or the block diagram of the methods, devices(systems), and computer program products according to the embodiments of the present disclosure. It should be understood that each step and/or block in the flowchart and/or the block diagram or the combination of the step and/or the block in the flowchart and/or the block diagram may be realized by the computer program instructions. The computer program instructions may be provided to a processor of a general computer, a dedicated computer, an embedded processor or other programmable data processing devices, so that an apparatus for realizing a function specified in one or more steps in the flowchart and/or one or more blocks in the block diagram is produced by executing instructions by the processor of the computer or the other programmable data processing devices.

These computer program instructions may also be stored in a computer readable memory for making the computer or the other programmable data processing devices function in a specific way, so that the instructions stored in the computer readable memory produce a manufacture including instruction apparatuses for realizing a function specified in one or more steps in the flowchart and/or one or more blocks in the block diagram.

These computer program instructions may also be loaded onto the computer or the other programmable data processing devices, so that the computer or the other programmable data processing devices performs a series of operation steps to produce a computer implemented process, so that the instructions performed on the computer or the other programmable data processing devices provides steps for realizing a function specified in one or more steps in the flowchart and/or one or more blocks in the block diagram.

Particularly, in an aspect, the computer program instructions corresponding to the configuration method in the embodiments of the present disclosure may be stored on a storage medium such as an optical disk, a hard disk, a USB disk or the like when the computer program instructions corresponding to the configuration method in the storage medium is read or executed by an electronic device, the following steps are performed.

At least one first storage apparatus is virtualized into a number of M booting virtual storage space, and at least one second storage apparatus is virtualized into a number of M data virtual storage space, the at least one first storage apparatus and the at least one second storage apparatus being connected to at least one switch, the at least one switch being connected to a number of M servers, and each server of the at least one switch being connected to a management apparatus in the server system, wherein M is an integer larger than or equal to 2.

The i-th first corresponding relationship between the i-th server of the number of M servers and the i-th booting virtual storage space of the number of M booting virtual storage space is created, with i from 1 to M in order, and a number of M first corresponding relationships are obtained when i is M;

The i-th second corresponding relationship between the i-th server and the i-th data virtual storage space of the number of M data virtual storage space is created, with i from 1 to M in order, and a number of M second corresponding relationships are obtained when i is M.

Optionally, the computer program instructions in the storage medium corresponding to the step of creating the i-th second corresponding relationship between the i-th server and the i-th data virtual storage space of the number of M data virtual storage space is created, with i from 1 to M in order, and a number of M second corresponding relationships are obtained when i is M, when executed in the detailed implementation, further comprises the steps of: virtualizing at least one network card connected to one or more switch(es) of the at least one switch into a number of M virtual network cards; creating the i-th third corresponding relationship between the i-th server and the i-th virtual network card in the number of M virtual network cards, with i from 1 to M in order, and obtaining a number of M third corresponding relationships when i is M.

Optionally, the computer program instructions in the storage medium further comprise the following steps, when executed in the detailed implementation: after creating the i-th first corresponding relationship, the i-th server is allowed to obtain the i-th server boot data of the i-th server from the i-th booting virtual storage space only.

Optionally, the computer program instructions in the storage medium further comprise the following steps, when executed in the detailed implementation, after creating the i-th second corresponding relationship, the i-th server is allowed to write data required to be written into the i-th data virtual storage space only, the i-th server is allowed to read data from each data virtual storage space of the number of M data virtual storage space.

Optionally, the computer program instructions in the storage medium further comprise the following steps, when executed in the detailed implementation, after creating the i-th third corresponding relationship, the i-th server is allowed to exchange data through the i-th virtual network card and a cloud side device.

In another aspect, the computer program instructions corresponding to the data exchange method in the embodiments of the present disclosure may be stored on a storage medium such as an optical disk, a hard disk, a USB disk or the like when the computer program instructions corresponding to the data exchange method in the storage medium is read or executed by an electronic device, the following steps are performed.

A data operation instruction for the i-th server of a number of M servers in the server system is obtained, at least one first storage apparatus and at least one second storage apparatus in the server system being connected to at least one switch, the at least one switch being connected to the number of M servers and each switch in the at least one switch being connected to a management apparatus in the server system.

The i-th virtual data apparatus corresponding to the i-th server is determined, based on a number of M corresponding relationships between the number of M servers and a number of M virtual data apparatuses for data read/write or exchange.

The data operation instruction is performed so that the i-th server performs corresponding data operation on the i-th virtual data apparatus.

Optionally, the computer program instructions in the storage medium corresponding to the step of obtaining a data operation instruction for the i-th server of a number of M servers in the server system further comprise the following steps, when executed in the detailed implementation: obtaining a system booting data reading instruction for reading the i-th system booting data of the i-th server from the i-th server of the number of M servers in the server system; or obtaining a data writing instruction for saving first data from the i-th server of the number of M servers in the server system; or obtaining a data exchange instruction for exchanging data with a cloud side device from the i-th server of the number of M servers in the server system.

Optionally, the computer program instructions in the storage medium corresponding to the step of determining the i-th virtual data apparatus corresponding to the i-th server, based on a number of M corresponding relationships between the number of M servers and a number of M virtual data apparatuses for data read/write or exchange further comprise the following steps, when executed in the detailed implementation: when the data operation instruction is the system booting data reading instruction, determining the i-th booting virtual storage space corresponding to the i-th server from a number of M booting virtual storage space obtained by virtualizing the at least one first storage apparatus, based on a number of M first corresponding relationships, wherein the number of M first corresponding relationships are corresponding relationships between the number of M servers and the number of M booting virtual storage space; and the step of performing the data operation instruction so that the i-th server performs corresponding data operation on the i-th virtual data apparatus comprises: performing the system booting data reading instruction, so that the i-th server reads the i-th server booting data from the i-th booting virtual storage space.

Optionally, the computer program instructions in the storage medium corresponding to the step of determining the i-th virtual data apparatus corresponding to the i-th server, based on a number of M corresponding relationships between the number of M servers and a number of M virtual data apparatuses for data read/write or exchange further comprise the following steps, when executed in the detailed implementation: determining the i-th data virtual storage space corresponding to the i-th server from a number of M data virtual storage space obtained by virtualizing the at least one second storage apparatus, based on a number of M second corresponding relationships, wherein the number of M second corresponding relationships are corresponding relationships between the number of M servers and the number of M data virtual storage space; and the step of performing the data operation instruction so that the i-th server performs corresponding data operation on the i-th virtual data apparatus comprises: performing the data writing instruction so that the i-th server writes the first data into the i-th data virtual storage space.

Optionally, the computer program instructions in the storage medium corresponding to the step of determining the i-th virtual data apparatus corresponding to the i-th server, based on a number of M corresponding relationships between the number of M servers and a number of M virtual data apparatuses for data read/write or exchange further comprise the following steps, when executed in the detailed implementation: determining the i-th virtual network card corresponding to the i-th server from a number of M virtual network cards obtained by virtualizing at least one network card connected to one or more switch in the at least one switch, based on a number of M third corresponding relationships, wherein the number of M third corresponding relationships are corresponding relationships between the number of M servers and the number of M virtual network cards; and the step of performing the data operation instruction so that the i-th server performs corresponding data operation on the i-th virtual data apparatus comprises: performing the data exchange instruction, so that the i-th server exchanges data with the cloud side device through the i-th virtual network card.

Although the embodiments of the present disclosure have been described above, those skilled in the art may make additional changes and variations to these embodiments once knowing the basis inventive concept, thus it is intended to comprise the embodiments and all the changes and variations falling within the scope of the present disclosure by the attached claims and its equivalents.

Apparently, those skilled in the art may make various changes and variations to the present disclosure without departing from the spirit and the scope of the present disclosure. In this way, it is intended to include such changes and variations by the present disclosure as long as such changes and variations to the present disclosure fall within the scope of the claims of the present disclosure and its equivalents.

1. A configuration method applied to a server system comprising:
virtualizing at least one first storage apparatus into a number of M booting virtual storage space, and virtualizing at least one second storage apparatus into a number of M data virtual storage space, the at least one first storage apparatus and the at least one second storage apparatus being connected to at least one switch, the at least one switch being connected to a number of M servers, and each server of the at least one switch being connected to a management apparatus in the server system, wherein M is an integer larger than or equal to 2;
creating the i-th first corresponding relationship between the i-th server of the number of M servers and the i-th booting virtual storage space of the number of M booting virtual storage space, with i from 1 to M in order, and obtaining a number of M first corresponding relationships when i is M;
creating the i-th second corresponding relationship between the i-th server and the i-th data virtual storage space of the number of M data virtual storage space, with i from 1 to M in order, and obtaining a number of M second corresponding relationships when i is M.

2. The method of claim 1, further comprising:
virtualizing at least one network card connected to one or more switch(es) of the at least one switch into a number of M virtual network cards;
creating the i-th third corresponding relationship between the i-th server and the i-th virtual network card in the number of M virtual network cards, with i from 1 to M in order, and obtaining a number of M third corresponding relationships when i is M.

3. The method of claim 1, wherein each switch of the at least one switch is a PCIE switch, and each network card of the at least one network card is a HBA network card.

4. The method of claim 3, wherein
after creating the i-th first corresponding relationship, the i-th server is allowed to obtain the i-th server boot data of the i-th server from the i-th booting virtual storage space only;
after creating the i-th second corresponding relationship, the i-th server is allowed to write data required to be written into the i-th data virtual storage space only, the i-th server is allowed to read data from each data virtual storage space of the number of M data virtual storage space;
after creating the i-th third corresponding relationship, the i-th server is allowed to exchange data through the i-th virtual network card and a cloud side device only.

5. A data exchange method applied to a server system, comprising:
obtaining a data operation instruction for the i-th server of a number of M servers in the server system, at least one first storage apparatus and at least one second storage apparatus in the server system being connected to at least one switch, the at least one switch being connected to the number of M servers and each switch in the at least one switch being connected to a management apparatus in the server system;
determining the i-th virtual data apparatus corresponding to the i-th server, based on a number of M corresponding relationships between the number of M servers and a number of M virtual data apparatuses for data read/write or exchange;
performing the data operation instruction so that the i-th server performs corresponding data operation on the i-th virtual data apparatus.

6. The method of claim 5, the step of obtaining the data operation instruction for the i-th server of a number of M servers in the server system comprising:
obtaining a system booting data reading instruction for reading the i-th system booting data of the i-th server from the i-th server of the number of M servers in the server system; or
obtaining a data writing instruction for saving first data from the i-th server of the number of M servers in the server system; or
obtaining a data exchange instruction for exchanging data with a cloud side device from the i-th server of the number of M servers in the server system.

7. The method of claim 6, wherein, when the data operation instruction is the system booting data reading instruction, the step of determining the i-th virtual data apparatus corresponding to the i-th server, based on the number of M corresponding relationships between the number of M servers and the number of M virtual data apparatuses for data read/write or exchange comprises:
determining the i-th booting virtual storage space corresponding to the i-th server from a number of M booting virtual storage space obtained by virtualizing the at least one first storage apparatus, based on a number of M first corresponding relationships, wherein the number of M first corresponding relationships are corresponding relationships between the number of M servers and the number of M booting virtual storage space; and
the step of performing the data operation instruction so that the i-th server performs corresponding data operation on the i-th virtual data apparatus comprises:
performing the system booting data reading instruction, so that the i-th server reads the i-th server booting data from the i-th booting virtual storage space.

8. The method of claim 6, wherein, when the data operation instruction is the data writing instruction, the step of determining the i-th virtual data apparatus corresponding to the i-th server, based on the number of M corresponding relationships between the number of M servers and the number of M virtual data apparatuses for data read/write or exchange comprises:
determining the i-th data virtual storage space corresponding to the i-th server from a number of M data virtual storage space obtained by virtualizing the at least one second storage apparatus, based on a number of M second corresponding relationships, wherein the number of M second corresponding relationships are corresponding relationships between the number of M servers and the number of M data virtual storage space; and
the step of performing the data operation instruction so that the i-th server performs corresponding data operation on the i-th virtual data apparatus comprises:
performing the data writing instruction so that the i-th server writes the first data into the i-th data virtual storage space.

9. The method of claim 6, wherein, when the data operation instruction is the data exchange instruction, the step of determining the i-th virtual data apparatus corresponding to the i-th server, based on the number of M corresponding relationships between the number of M servers and the number of M virtual data apparatuses for data read/write or exchange comprises:
determining the i-th virtual network card corresponding to the i-th server from a number of M virtual network cards obtained by virtualizing at least one network card connected to one or more switch(es) of the at least one switch, based on a number of M third corresponding relationships, wherein the number of M third corresponding relationships are corresponding relationships between the number of M servers and the number of M virtual network cards; and
the step of performing the data operation instruction so that the i-th server performs corresponding data operation on the i-th virtual data apparatus comprises:
performing the data exchange instruction, so that the i-th server exchanges data with the cloud side device through the i-th virtual network card.

10. A server system comprising:
at least one first storage apparatus corresponding to a number of M booting virtual storage space;
at least one second storage apparatus corresponding to a number of M data virtual storage space;
at least one switch connected to the at least one first storage apparatus and the at least one second storage apparatus;
a number of M servers connected to the at least one switch;
a management apparatus connected to the number of M servers;
wherein, through the management apparatus, the i-th first corresponding relationship is created between the i-th server of the number of M servers and the i-th booting virtual storage space of the number of M booting virtual storage space, so that a total number of M first corresponding relationships are created; and the i-th second corresponding relationship is created between the i-th server and the i-th data virtual storage space of the number of M data virtual storage space, so that a total number of M second corresponding relationships are created.

11. The server system of claim 10, wherein the server system further comprises at least one network card connected to one or more switch(es) of the at least one switch, the at least one switch being virtualized into a number of M virtual network cards;
wherein the i-th third corresponding relationship is created between the i-th server of the number of M servers and the i-th virtual network card of the number of M virtual network cards, wherein i is anyone integer between 1 and M.

12. The server system of claim 10, wherein each switch of the at least one switch is a PCIE switch, and each network card of the at least one network card is a HBA network card.

13. The server system of claim 12, wherein
the i-th server is allowed to obtain the i-th server boot data of the i-th server from the i-th booting virtual storage space only;
the i-th server is allowed to write data required to be written into the i-th data virtual storage space only, the i-th server is allowed to read data from each data virtual storage space of the number of M data virtual storage space;
the i-th server is allowed to exchange data through the i-th virtual network card and a cloud side device.
